(19) United States
(12) Patent Application Publication
(10) Pub. No.: US 2020/0198233 A1
(43) Pub. Date: Jun. 25, 2020

(54) 3D PRINTING TECHNOLOGY-BASED PROCESSING APPARATUS AND METHOD

(71) Applicant: BEIJING UNIVERSITY OF CHEMICAL TECHNOLOGY, Chaoyang District, Beijing (CN)

(72) Inventors: Weimin YANG, Chaoyang District, Beijing (CN); Zhiwei JIAO, Chaoyang District, Beijing (CN); Pengcheng XIE, Chaoyang District, Beijing (CN); Jing TAN, Chaoyang District, Beijing (CN); Haoyi LI, Chaoyang District, Beijing (CN); Ying AN, Chaoyang District, Beijing (CN); Hua YAN, Chaoyang District, Beijing (CN); Lisheng CHENG, Chaoyang District, Beijing (CN); Yumei DING, Chaoyang District, Beijing (CN); Haopeng MA, Chaoyang District, Beijing (CN); Xiulei WANG, Chaoyang District, Beijing (CN); Rongjun LI, Chaoyang District, Beijing (CN); Chaoqun LIAO, Chaoyang District, Beijing (CN)

(21) Appl. No.: 16/610,034

(22) PCT Filed: Mar. 21, 2019
(86) PCT No.: PCT/CN2019/079074

§ 371 Date: Oct. 31, 2019

(30) Foreign Application Priority Data
Mar. 22, 2018 (CN) 201810237554.1
Apr. 10, 2018 (CN) 201810314626.8
Apr. 10, 2018 (CN) 201810315765.2
Jun. 13, 2018 (CN) 201810606091.1

(51) Int. Cl. B29C 64/188; B29C 64/118; B29C 64/393; B33Y 10/00; B33Y 30/00; B33Y 40/20; B33Y 50/02

(52) U.S. Cl. CPC B29C 64/188; B29C 64/118; B29C 64/393; B33Y 50/02; B33Y 30/00; B33Y 40/20; B33Y 10/00

(57) ABSTRACT

A 3D printing technology-based processing apparatus and method includes a frame, an injection unit, and a molding unit. A melted polymer filler can be filled into a blind hole or a passageway of a 3D printed product to improve overall strength of the product. A 3D printed product having a mortise and tenon shaped mechanical engagement structure is disclosed. The printed product having the mortise and tenon shaped structure has higher tensile strength and shear strength. The present apparatus effectively resolves a problem of warped and deformed products due to an excessive temperature difference between the product and an environment during printing. The method uses an optimized printing process to reduce the fabrication processes of a support structure, reduce consumables required for building the structure, and improve the printed surface quality of the printed product.

### CROSS-REFERENCE TO RELATED APPLICATIONS

The present application claims priority to Chinese patent application No. 201810237554.1, filed with the Patent Office of the People's Republic of China on Mar. 22, 2018 and entitled “COMBINED MACHINING APPARATUS AND METHOD BASED ON 3D PRINTING TECHNOLOGY”, priority to Chinese patent application No. 201810314626.8, filed with the Patent Office of the People's Republic of China on Apr. 10, 2018 and entitled “3D PRINTING MOLDING PLATFORM FOR PREVENTING PRODUCTS FROM WARPING”, priority to Chinese patent application No. 201810606091.1, filed with the Patent Office of the People's Republic of China on Jun. 13, 2018 and entitled “3D PRINTING FILLING STRUCTURE WITH MORTISE AND TENON JOINT STRUCTURE AND PROCESSING PROCESS THEREOF”, and priority to Chinese patent application No. 201810315765.2, filed with the Patent Office of the People's Republic of China on Apr. 10, 2018 and entitled “3D PRINTING AND MOLDING APPARATUS AND METHOD WITH MAGNETIC ASSISTANT MOLDING”, which are incorporated herein by reference in their entireties.

### TECHNICAL FIELD

The present application relates to the field of printing technologies, and in particular, to a 3D printing technology-based processing apparatus and method.

### BACKGROUND OF THE INVENTION

3D printing technology is one of the rapid prototyping technologies, and it is a technology of constructing objects by layer-by-layer printing on the basis of a digital model file and using bondable material such as a powdery metal or plastic. The object constructed by using the 3D printing technology is a 3D printed product.

However, during a research process of the present application, the inventor finds that an object is constructed layer by layer by a 3D print processing apparatus in the prior art, and a 3D printed product is molded in a layer-by-layer stacking manner, that is, each 3D printed product is formed by stacking a plurality of horizontal planes. Therefore, the 3D printed product has a low strength in a horizontal direction, further resulting in a weak strength of the 3D printed product, and may even result in that the 3D printed product cannot be used directly in actual productions.

### SUMMARY OF THE INVENTION

To resolve a problem of a low strength in a 3D printed product printed by a 3D print processing apparatus, embodiments of the present application disclose a 3D printing technology-based processing apparatus and method.

According to a first aspect of the present application, a 3D printing technology-based processing apparatus is disclosed, including:
a frame, an injection unit, and a molding unit, wherein
the injection unit includes a micro injection molding machine, a vacuumizer, a connector, a dual-channel one-way valve 5, and a rubber gasket;
the molding unit includes a fused deposition modeling extruder, a prototyping platform, and a three-dimensional movement module;
a die of the micro injection molding machine is connected to a 3D printed product by using the connector, and the dual-channel one-way valve controls opening and closing of an vacuumizer channel and an injection path in the connector;
the prototyping platform is mounted on the three-dimensional movement module;
the micro injection molding machine and the fused deposition modeling extruder are fixedly mounted on the frame side by side; and
the fused deposition modeling extruder includes a heating nozzle, and the fused deposition modeling extruder feeds a polymer material filament into the heating nozzle by means that gears rotate in opposite directions to engage, and fuses, plasticizes, and extrudes the polymer material filament by using the heating nozzle, wherein extruded fuses enter, under an three-dimensional movement of the prototyping platform, a blind hole or a passageway of the 3D printed product for stack molding.

In a feasible implementation, the connector is a tapered connector, and is mounted at the die of the micro injection molding machine; and
an outside of the connector is winded with a heating ring, a lower end of the connector is mounted with the rubber gasket, an interior of the connector is a three-way structure, wherein an upper end of the connector is connected to the die of the injection molding machine, a lower end of the connector is connected to a blind hole opening or a passageway opening of the 3D printed product, a side opening of the connector is connected to the vacuumizer, and the dual-channel one-way valve is disposed within the connector.

In a feasible implementation, the processing apparatus further includes:
a taper hole prototyping platform system, a heating storage tank system, and a platform lifting system, wherein
the taper hole prototyping platform system includes a metal substrate, a scraper lead screw, and a scraper; the heating storage tank system includes a temperature controlled heating plate and a storage tank; and the platform lifting system includes a stepper motor and a platform lead screw;
a plurality of taper holes arranged in an array are machined in the metal substrate, the metal substrate and the prototyping platform collectively constitutes a taper hole platform, the taper hole platform is connected to the storage tank by using the platform lead screw and is mounted above the storage tank, the taper hole platform ascends or descends and is leveled in a vertical direction, and the taper hole platform is a support platform of the 3D printed product;
the scraper is connected to the taper hole platform by using a guide rail, and the scraper moves in a horizontal direction under control of the scraper lead screw;
the storage tank is connected to a 3D printer by using the three-dimensional movement module, and both the storage tank and the taper hole platform are enabled to ascend or descend in the vertical direction through the movement of the three-dimensional movement module;
the temperature controlled heating plate is pasted at a bottom portion of the storage tank, and the temperature controlled heating plate is heated by an internal resistant of itself, and transfers heat to the storage tank, to melt a filling material in the storage tank;
the platform lifting system is fixed at the left and right of the storage tank, and the platform lifting system controls the ascending and the descending of the taper hole platform relative to the storage tank by controlling the stepper motor to drive the platform lead screw to rotate;
when the taper hole platform moves downward to be embedded into the storage tank under the rotation of the platform lead screw, the taper hole platform squeezes the filling material melted in the storage tank to fill up a taper hole in the taper hole platform, and the filling material that fills up the taper hole is flush with the taper hole platform, so that the 3D printed product and the filling material in the taper hole of the taper hole platform are melted and adhered as an integral; and
the scraper is mounted at an upper surface of the taper hole platform, and is controlled to move by the scraper lead screw and the stepper motor, a working surface of the scraper is flush with an upper plane of the taper hole platform, and when the filling material in the storage tank is melted and fills up the taper hole, the ed material and the metal substrate are in a same plane under the action of the scraper, to serve as a fixed joint face of a print model.

In a feasible implementation, the storage tank is connected to the 3D printer by using the three-dimensional movement module, and is controlled by the three-dimensional movement module to move in the vertical direction. In a feasible implementation, the stepper motor is fixed at both sides of the storage tank, and the platform lead screw is connected to the stepper motor, the taper hole platform is connected onto the platform lead screw, and the platform lead screw rotates to drive the taper hole platform to ascend or descend, control a distance between the taper hole platform and the storage tank, and control the melted filling material to fill up the taper hole; and
after printing of the 3D printed product is completed, the taper hole platform is enabled to ascend through the rotation of the platform lead screw, so that the printed 3D printed product and the filling material in the taper hole are fractured and separated at a tapered vertex, thereby separating the 3D printed product from the taper hole platform.

In a feasible implementation, there is a mortise and tenon shaped mechanical engagement structure between adjacent filaments of a printed 3D printed product; and
various staggered plane units engage with each other in a staggered manner and are superposed on each other to form an integral structure of the 3D printed product, wherein a mechanical engagement structure printed in one processing cycle is referred to as a staggered plane unit, and each staggered plane unit is a molding plane with regular concave-convex structures at a surface thereof.

In a feasible implementation, during a process of printing the staggered plane unit, a movement of the 3D printer or the prototyping platform in a vertical direction is adjusted by using the three-dimensional movement module, and a protrusion-recess structure in the mortise and tenon shaped mechanical engagement structure is printed by adjusting an amount of fuses extruded by the 3D printer, to achieve the half-wire diameter printing; and
a structure constituted by the staggered plane units is a staggered laminated structure, and in the staggered laminated structure, a height difference between same layers of adjacent filaments in a horizontal direction is half of a wire diameter.

In a feasible implementation, a material of the prototyping platform is a high magnetic permeability material; and
the processing apparatus further includes:
a magnetic assistant system and a control system, where
the magnetic assistant system includes a wire bushing box, an electromagnetic coil, an iron core, and a heat dissipation device, and the control system includes a 3D printer control system, a magnetic field control system, and a magnetic isolation box;
the 3D printer control system and the magnetic field control system are disposed within the magnetic isolation box, to prevent magnetic fields of the 3D printer control system and the magnetic field control system from interfering with the control system, conducting wires of the 3D printer control system and the magnetic field control system are migrated from internal of the magnetic isolation box, and the magnetic isolation box is disposed at one side of the 3D printer;
the wire bushing box includes an upper housing, a lower housing, a side housing, and an internal isolation zone, wherein the side housing is made of a low magnetic permeability material, the upper housing and the lower housing are made of high magnetic permeability materials, the internal isolation zone is in a rectangular grid structure, a side length of a grid in the rectangular grid structure is consistent with an outer diameter of the electromagnetic coil, an electromagnet constituted by the electromagnetic coil and the iron core is disposed within a rectangular grid constituted by the internal isolation zone, and the internal isolation zone is made of a material having a low magnetic permeability and electric field isolation effects;
the wire bushing box forms a magnetism creation platform, the magnetism creation platform includes an upper-layer magnetism creation platform and a lower-layer magnetism creation platform, the upper-layer magnetism creation platform is disposed at a top portion of a 3D printer, the lower-layer magnetism creation platform is mounted below the prototyping platform, the lower-layer magnetism creation platform moves in a vertical direction along with the prototyping platform, and the upper-layer magnetism creation platform is parallel to the lower-layer magnetism creation platform;
the magnetic field control system is configured to control a current of the electromagnetic coil and an operation of the heat dissipation device, and the magnetic field control system monitors an operating status of the 3D printer, controls on or off of the current of the electromagnetic coil and a value of the current of the electromagnetic coil based on the operating status of the 3D printer, and controls the operation of the heat dissipation device based on a temperature in the wire bushing box, so that the temperature in the wire bushing box is kept within a reasonable range, until the magnetism creation platform is no longer used during this printing process and a temperature within the magnetism creation platform falls to a room temperature;
during a 3D printing process, when the 3D printer fuses and extrudes a material and the material is in contact with the prototyping platform, the magnetic field control system is configured to detect a contact surface area of the material with the prototyping platform, and apply a current to a electromagnetic coil in a corresponding area of the lower-layer magnetism creation platform that is a vertical projection of the contact surface area, so that a magnetic metal material in the material is attracted by a magnetic force of the lower-layer magnetism creation platform;
when the 3D printer control system determines that a cantilever structure needs to be printed, the magnetic field control system is configured to control the lower-layer magnetism creation platform to stop working, the magnetic field control system applies a current to a electromagnetic coil in a corresponding area of the upper-layer magnetism creation platform that is a vertical projection of the cantilever structure, and a value of the applied current is in a positive correlation with an amount of the material that is extruded by the 3D printer under control of the 3D printer control system, so that a melted material of the cantilever structure and extruded at a nozzle of the 3D printer is suspended in the air, and is cooled and solidified during the suspending process, thereby achieving the printing of the cantilever structure without support; and
when printing of the cantilever structure is completed, the upper-layer magnetism creation platform stops working, and the lower-layer magnetism creation platform continues to work, to firmly attract the 3D printed product onto the prototyping platform.

In a feasible implementation, the low magnetic permeability material applied to the side housing is aluminum alloy, and the high magnetic permeability materials applied to the upper housing and the lower housing are industrial pure iron;
the heat dissipation device includes fans, the fans are mounted at a front surface, a back surface, a left surface, and a right surface of the wire bushing box and are symmetrical with each other, and the magnetic field control system controls a working speed of the fan based on the temperature in the wire bushing box; and
the magnetic isolation box is made of a low magnetic permeability material, and the magnetic isolation box completely wraps the 3D printer control system and the magnetic field control system.

According to a second aspect of the present application, a 3D printing technology-based processing method is disclosed. The processing method is applied to the 3D printing technology-based processing apparatus disclosed in any item of the first aspect of the present application, and includes:
obtaining a 3D printed product by using the 3D printer at a model designing stage of the 3D printed product according to requirements on strength of the 3D printed product, wherein a plurality of blind holes or passageways are disposed along a vertical direction in the 3D printed product;
driving, by the three-dimensional movement module, the prototyping platform to move to be right below the micro injection molding machine and move upward, so that an upper surface of the 3D printed product is kept close to a rubber cushion below the connector; and then rotating the dual-channel one-way valve within the connector to open the vacuumizer channel and close the injection path, where the vacuumizer works to exhaust air within the blind hole or the passageway of the 3D printed product through the blind hole opening or the passageway opening, to form vacuum in the blind hole or the passageway; and
rotating the dual-channel one-way valve again to close the vacuumizer channel and open the injection path, where the micro injection molding machine injects a melted polymer filler into the blind hole or the passageway.

In a feasible implementation, when the processing apparatus includes the taper hole prototyping platform system, the heating storage tank system, and the platform lifting system according to claim 3, the processing method further includes:
transferring heat to the storage tank by using the temperature controlled heating plate to melt the filling material in the storage tank, and controlling, through a rotation and a downward movement of the platform lead screw, the taper hole platform to move downward and become in contact with the filling material melted in the storage tank, to embed the fused filling material into the taper hole;
driving, by the scraper lead screw, the scraper to scrape off a protrusion portion of the filling material that is higher than the upper plane of the taper hole platform, so that the dot-like filling material in the taper hole of the taper hole platform and an upper plane of the taper hole form an array-point plane, wherein the array-point plane and the metal substrate form a composite material plane; and
after printing of the 3D printed product is completed, enabling the taper hole platform to ascended through the rotation of the platform lead screw, so that the printed 3D printed product and the filling material in the taper hole are fractured and separated at a tapered vertex, thereby separating the 3D printed product from the taper hole platform.

In a feasible implementation, when the processing apparatus includes the magnetic assistant system and the control system according to claim 8, the processing method further includes:
turning on the heat dissipation device by the magnetic field control system, until the magnetism creation platform is no longer used during this printing process and the temperature within the magnetism creation platform falls to the room temperature;
during the 3D printing process, when the 3D printer melts and extrudes a material and the material is in contact with the prototyping platform, detecting, by the magnetic field control system, a contact surface area of the material with the prototyping platform, and applying a current to a electromagnetic coil in a corresponding area of the lower-layer magnetism creation platform that is a vertical projection of the contact surface area, so that a magnetic metal material in the material is attracted by a magnetic force of the lower-layer magnetism creation platform;
when the 3D printer control system determines that a cantilever structure needs to be printed, controlling, by the magnetic field control system, the lower-layer magnetism creation platform to stop working, wherein the magnetic field control system applies a current to a electromagnetic coil in a corresponding area of the upper-layer magnetism creation platform that is a vertical projection of the cantilever structure, and a value of the applied current is in a positive correlation with an amount of the material that is extruded by the 3D printer under the control of the 3D printer control system, so that a melted material of the cantilever structure and extruded at a nozzle of the 3D printer is suspended in the air, and is cooled and solidified during the suspending process, thereby achieving the printing of the cantilever structure without support; and
when printing of the cantilever structure is completed, enabling the upper-layer magnetism creation platform to stop working, and enabling the lower-layer magnetism creation platform to continue to work, to firmly magnetically attract the 3D printed product onto the prototyping platform.

According to the solutions of the present application, the melted polymer filler can be filled into the blind hole or the passageway of the 3D printed product, to improve overall strength of the 3D printed product.

Further, in the solutions of the present application, a 3D printed product having a mortise and tenon shaped mechanical engagement structure is also disclosed. Compared with the prior art, in case of the same amounts of materials, the 3D printed product having the mortise and tenon shaped mechanical engagement structure disclosed in the present application has higher tensile strength and shear strength. Therefore, the quality of the 3D printed product is better.

Moreover, according to the solutions disclosed in the present application, a problem, during 3D printing, particularly a process of printing a large-scale product by an existing prototyping platform, that warpage and deformations occur to the product due to an excessive temperature difference between the product and an environment is effectively resolved by using a principle that a polymer product is bonded in a melting status. In addition, after the printing is completed, the filling material in the taper hole is fractured and separated at a tapered vertex, helping the 3D printed product be separated from the taper hole platform after being molded. This facilitates pickup of components, and there is no need to heat the temperature controlled heating plate in the whole printing process, thereby consuming less energy.

In addition, the method disclosed in the embodiments of the present application can optimize a 3D printing process of a cantilever structure made of a polymer-based metal composite material, to reduce building processes of a support structure and reduce consumables required for building the support structure; and improve the printed surface quality of the cantilever structure of the 3D printed product, to avoid damages to a surface in a process of removing support materials, and effectively prevent the 3D printed product from warping.

### BRIEF DESCRIPTION OF THE DRAWINGS

In order to more clearly describe the technical solutions of the present application, the accompanying drawings to be used in the embodiments are briefly illustrated below. Obviously, persons of ordinary skills in the art can also derive other accompanying drawings according to these accompanying drawings without an effective effort.

FIG. 1 is an overall schematic diagram of a 3D printing technology-based processing apparatus according to an embodiment of the present application;

FIG. 2 is a schematic diagram of a connector of a 3D printing technology-based processing apparatus according to an embodiment of the present application;

FIG. 3 is a schematic diagram of a 3D printed product of a 3D printing technology-based processing apparatus according to an embodiment of the present application;

FIG. 4 is an overall schematic diagram of a 3D printing technology-based processing apparatus according to an embodiment of the present application, wherein components related to preventing a 3D printed product from warping are disposed in the processing apparatus;

FIG. 5 is a schematic diagram of connection between a 3D printed product and a taper hole platform in a 3D printing technology-based processing apparatus according to an embodiment of the present application;

FIG. 6 is a partial schematic diagram of a scraper in a 3D printing technology-based processing apparatus according to an embodiment of the present application;

FIG. 7 is a mounting schematic diagram of a taper hole platform and a 3D printer in a 3D printing technology-based processing apparatus according to an embodiment of the present application;

FIG. 8 is a top view of each layer of staggered plane unit of a 3D printed product obtained according to an embodiment of the present application;

FIG. 9 is a detailed exploded view of a mortise and tenon shaped mechanical engagement structure of a 3D printed product obtained according to an embodiment of the present application;

FIG. 10 is a detailed combined diagram of a mortise and tenon shaped mechanical engagement structure of a 3D printed product obtained according to an embodiment of the present application;

FIG. 11 is an exploded view of combination of each staggered plane unit of a 3D printed product obtained according to an embodiment of the present application;

FIG. 12 is a combined diagram of combination of each staggered plane unit of a 3D printed product obtained according to an embodiment of the present application;

FIG. 13 is an overall schematic diagram of a 3D printing technology-based processing apparatus according to an embodiment of the present application, wherein components related to avoiding the quality of the surface of a cantilever structure of a 3D printed product from deteriorating are disposed in the processing apparatus;

FIG. 14 is a schematic diagram of a magnetism creation platform in a 3D printing technology-based processing apparatus according to an embodiment of the present application;

FIG. 15 is a schematic diagram of a wire bushing box of a magnetism creation platform in a 3D printing technology-based processing apparatus according to an embodiment of the present application; and

FIG. 16 is a scene schematic diagram of a plurality of suspending mechanical arms for printing according to an embodiment of the present application.

List of reference numbers in the figures:
1 frame;
2 micro injection molding machine;
3 vacuumizer;
4 fused deposition modeling extruder;
5 dual-channel one-way valve;
6 connector;
7 rubber gasket;
8 a blind hole or a passageway of a 3D printed product;
9 3D printed product;
10 prototyping platform;
11 three-dimensional movement module;
20 filling material;
21 scraper;
22 taper hole platform;
23 scraper lead screw;
24 stepper motor;
25 platform lead screw;
26 temperature controlled heating plate;
27 storage tank;
31 upper-layer magnetism creation platform;
32 lower-layer magnetism creation platform;
33 magnetic isolation box;
41 wire bushing box;
42 mounting hole of a fan;
43 electromagnetic coil;
44 iron core;
45 suspending 3D printed product;
46 3D printing mechanism arm;
9-1 filament in a mortise and tenon shaped mechanical engagement structure;
9-2 filament in the mortise and tenon shaped mechanical engagement structure;
9-3 filament in the mortise and tenon shaped mechanical engagement structure;
9-4 filament in the mortise and tenon shaped mechanical engagement structure;
9-5 filament in the mortise and tenon shaped mechanical engagement structure;
9-6 filament in the mortise and tenon shaped mechanical engagement structure;
11-1 staggered plane unit at an n^{th} layer;
11-2 staggered plane unit at a (n+1)^{th} layer;
11-3 staggered plane unit at a (n+2)^{th} layer.

### DETAILED DESCRIPTION OF THE EMBODIMENTS

To resolve a problem of the weak strength of a 3D printed product in the prior art, the present application discloses a 3D printing technology-based processing apparatus and method.

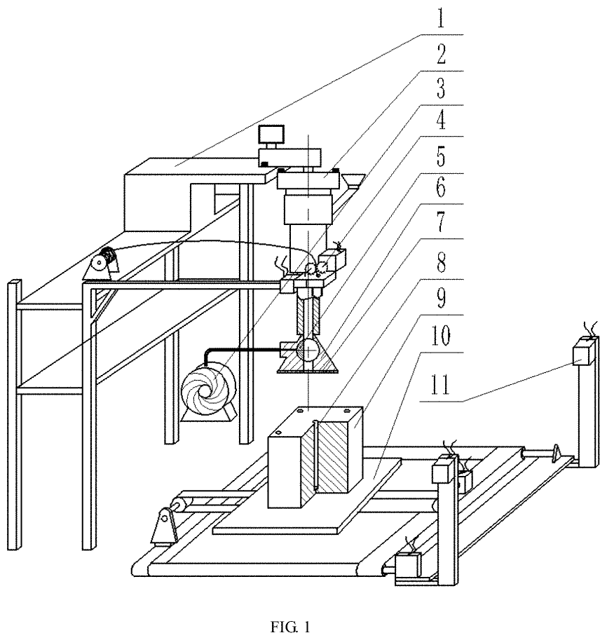

According to a first embodiment of the present application, a 3D printing technology-based processing apparatus is disclosed. Referring to a schematic structural diagram shown in FIG. 1, the apparatus includes a frame 1, an injection unit, and a molding unit.

The injection unit includes a micro injection molding machine 2, a vacuumizer 3, a connector 6, a dual-channel one-way valve 5, and a rubber gasket 7. The molding unit includes a fused deposition modeling extruder 4, a prototyping platform 10, and a three-dimensional movement module 11.

A die of the micro injection molding machine 2 is connected to a 3D printed product by using the connector 6, and the dual-channel one-way valve 5 controls opening and closing of an vacuumizer channel and an injection path in the connector 6. The 3D printed product may be considered as a 3D printed product to be processed, Which may be further processed to obtain a finally processed 3D printed product.

In addition, the prototyping platform 10 is mounted on the three-dimensional movement module 11.

The micro injection molding machine 2 and the fused deposition modeling extruder 4 are fixedly mounted on the frame 1 side by side.

The fused deposition modeling extruder 4 includes a heating nozzle. The fused deposition modeling extruder 4 feeds a polymer material filament into the heating nozzle by means that gears rotate in opposite directions to engage with each other, and the polymer material filament is melted, plasticized, and then extruded by the heating nozzle. Extruded fuses enter, under a three-dimensional movement of the prototyping platform 10, a blind hole or a passageway of the 3D printed product for stack molding, thereby obtaining the processed 3D printed product. In this case, the extruded fuses are a melted filler, and a molded product is the processed 3D printed product.

In this embodiment of the present application, according to requirements on strength of the 3D printed product, a plurality of blind holes or passageways are disposed along a vertical direction in a model of the 3D printed product at a model designing stage of the 3D printed product, and an entity of the model is obtained by using the 3D printer. Subsequently, the melted filler is extruded into the blind hole or the passageway by the micro injection molding machine 2. The melted filler is molded in the blind hole or the passageway, so that the melted filler that is extruded into the blind hole or the passageway serves as a framework of the 3D printed product, which effectively improve an anti-shearing capability of the 3D printed product in a horizontal direction, and improve the strength of the 3D printed product, thereby resolving the problem in the prior art. Therefore, the apparatus disclosed in this embodiment of the present application can improve the strength of the 3D printed product to some extent, effectively prolong service life of the 3D printed product, and enlarge an application range of the 3D printing technology, helping further apply the 3D printing technology to actual industrial production.

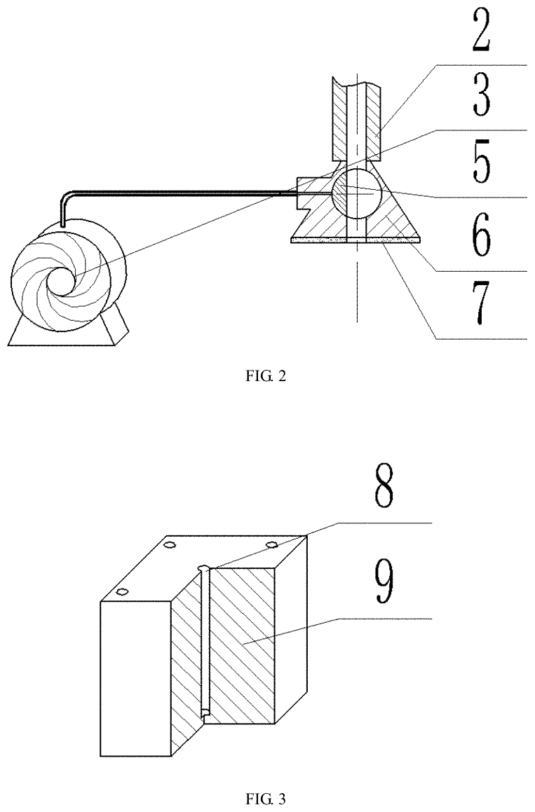

Further, as shown in FIG. 2, in the processing apparatus disclosed in this embodiment of the present application, the connector 6 is a tapered connector 6, and the connector 6 is mounted at the die of the micro injection molding machine 2. In addition, a heating ring is wound around the outside of the connector 6, to ensure that the filled melted filler has better flow ability. A lower end of the connector 6 is mounted with the rubber gasket 7, and an interior of the connector 6 is a three-way structure. An upper end of the connector 6 is connected to a die of an injection molding machine, a lower end of the connector 6 is connected to a blind hole opening or a passageway opening of the 3D printed product, a side opening of the connector 6 is connected to the vacuumizer 3, and the dual-channel one-way valve 5 is disposed within the connector 6. In this case, the 3D printed product may be shown in FIG. 3.

In this embodiment of the present application, according to the requirements on the strength of the 3D printed product, a plurality of blind holes or passageways are disposed along a vertical direction in the 3D printed product at a model designing stage of the 3D printed product, and the 3D printed product is obtained by using the 3D printer. The 3D printed product having a plurality of blind holes or passageways is the 3D printed product to be processed. An entity of the 3D printed product may be printed by the fused deposition modeling extruder 4 which is usually a part of the 3D printer. After the printing is finished by the fused deposition modeling extruder 4, the prototyping platform 10 is driven by the three-dimensional movement module 11 to move to be right below the micro injection molding machine 2 and then move upward, so that an upper surface of the entity is tightly adhered to a rubber cushion below the connector; and then the dual-channel one-way valve 5 within the connector 6 is rotated to open the vacuumizer channel and close the injection path. The vacuumizer 3 works to exhaust air within the blind hole or the passageway of the 3D printed product through the blind hole opening or the passageway opening, so as to form vacuum in the blind hole or the passageway, thereby facilitating the processing of subsequent injection molding. Subsequently, the dual-channel one-way valve 5 is rotated again to close the vacuumizer channel and open the injection path. A melted polymer filler is injected into the blind hole or the passageway by the micro injection molding machine 2. Specifically, the micro injection molding machine 2 may melt and plasticize a polymer material by using a plasticizing and fusing apparatus disposed therein, to obtain the corresponding melted polymer filler, and then inject the melted polymer filler into the blind hole or the passageway. Because the micro injection molding machine 2 has a high injection pressure, the melted polymer filler in the blind hole or the passageway may be enabled to be dense without stratification under a combined action of the injection pressure and the atmospheric pressure. The melted polymer filler in the blind hole or the passageway has better shear strength as compared with a portion from a fused deposition product. Moreover, the melted polymer filler is made of a polymer material, and a base material of the 3D printed product is usually also a polymer material. Therefore, a base material of the melted polymer filler has similar properties with the base material of the 3D printed product, and a filling portion is well bonded with the base material, thus being able to improve overall strength of the 3D printed product.

Further, in this embodiment of the present application, the prototyping platform 10 may move in three-dimensional directions along with the three-dimensional movement module 11. The three-dimensional movement module 11 may be manually controlled, or may be controlled by a first control apparatus. Moreover, the dual-channel one-way valve 5 may also be manually controlled, or may alternatively be controlled by the first control apparatus. The first control apparatus may be a terminal device having a control function, such as computer and so on.

In addition, in the case of 3D printing, a fused deposition molding (FDM) technology which is one of the 3D printing technologies may be applied to some scenarios. When applying the fused deposition molding (FDM) technology to perform the 3D printing, the prototyping platform 10 is a baseboard that supports the model during the 3D printing process, and melted polymer material layers are stacked on the baseboard, to form the 3D printed product. Most of materials used for the printing are an acrylonitrile butadiene styrene copolymers (ABS) material or a polylactic acid (PLA) material. During the printing process, due to a great temperature difference between the printed product and an environment, a thermal stress may be generated at a contact surface between the model and the prototyping platform 10. As a result, the model warps and is separated from a prototyping platform, resulting in a molding failure of the 3D printed product.

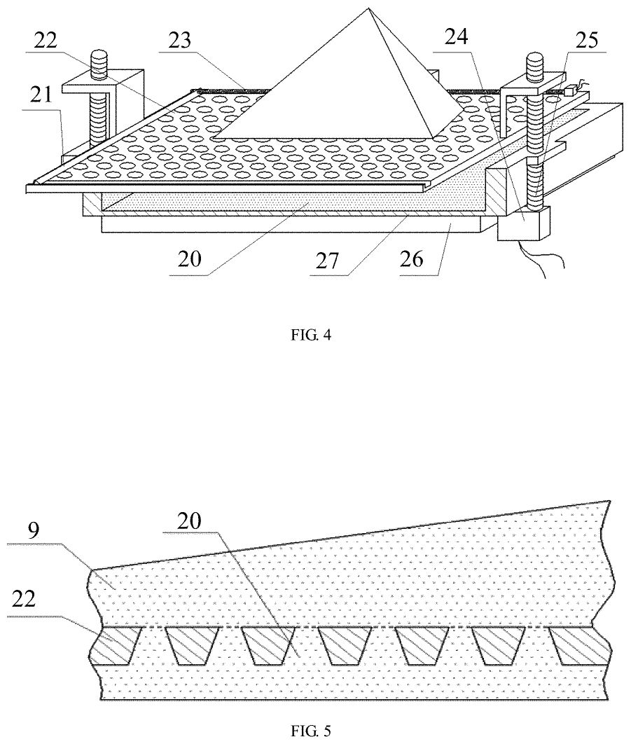

To resolve this problem, in another embodiment of the present application (see FIG. 4), the processing apparatus further includes a taper hole prototyping platform 10 system, a heating storage tank system, and a platform lifting system.

The taper hole prototyping platform 10 system includes a metal substrate, a scraper lead screw 23, and a scraper 21. The heating storage tank system includes a temperature controlled heating plate 26 and a storage tank 27. The platform lifting system includes a stepper motor 24 and a platform lead screw 25.

A plurality of taper holes arranged in an array are processed in the metal substrate. The metal substrate and the prototyping platform 10 collectively constitute a taper hole platform 22. The taper hole platform 22 is connected to the storage tank 27 by means of the platform lead screw 25 and is mounted above the storage tank. The taper hole platform 22 ascends or descends and is leveled in a vertical direction. The taper hole platform is a support platform of the 3D printed product.

Specifically, the taper hole platform 22 can ascend or descend and be leveled in the vertical direction (that is, a Z-axis) under an action of the platform lead screw 25.

The scraper 21 is connected to the taper hole platform 22 by means of a guide rail, and the scraper 21 moves in a horizontal direction (that is, an X-axis) under control of the scraper lead screw 23. In addition, the storage tank 27 is connected to a 3D printer by means of the three-dimensional movement module 11, and both the storage tank 27 and the taper hole platform 22 are configured to achieve lifting and leveling in the vertical direction (that is, the Z-axis) by means of movement of the three-dimensional movement module 11.

The temperature controlled heating plate 26 is attached to a bottom portion of the storage tank 27. The temperature controlled heating plate is heated by its own internal resistant, and transfers heat to the storage tank 27, so as to fuse a filling material in the storage tank 27. Specifically, the temperature controlled heating plate 26 may be a heating plate whose temperature is controllable. Generally, the filling material may be a PLA material, or may be other materials the same as that of the 3D printed product.

The platform lifting system is fixed at the left and right of the storage tank 27. The platform lifting system controls the ascending and the descending of the taper hole platform 22 relative to the storage tank 27 by controlling the stepper motor 24 to drive the platform lead screw 25 to rotate.

When the taper hole platform 22 moves downward to be embedded into the storage tank 27 by the rotation of the platform lead screw 25, the taper hole platform 22 extrudes the melted filling material in the storage tank 27 to fill up taper holes in the taper hole platform 22. Moreover, the filling material that fills up the taper holes is flush with the taper hole platform 22, so that the filling material 20 in the taper holes of the taper hole platform 22 and the 3D printed product 24 are melted and adhered as an integral.

The scraper 21 is mounted on an upper plane of the taper hole platform 22, and is controlled to move by the scraper lead screw 23 and the stepper motor. A working surface of the scraper 21 is flush with an upper plane of the taper hole platform 22. When the filling material in the storage tank 27 is melted and fills up the taper holes, the melted filling material and the metal substrate are in a same plane under the action of the scraper, to serve as a fixed joint face of a print model. The stepper motor may be driven, and then the stepper motor further drives the scraper lead screw 23 to move.

That is, in the processing apparatus disclosed in this embodiment of the present application, the storage tank 27 is a support surface of the taper hole platform 22, and is configured to be connected to the 3D printer. The storage tank 27 is connected to the 3D printer by means of the three-dimensional movement module 11, and achieves movement in the vertical direction (that is, the Z-axis) under the control of the three-dimensional movement module 11.

Specifically, the taper hole platform 22, serving as the support platform for printing the 3D product, moves downward by the rotation of the platform lead screw 25, so as to contact with the melted filling material 20 in the storage tank 27 (that is, the filling material in the storage tank). The melted filling material 20 is embedded into the taper holes. The scraper lead screw 23 drives the scraper 21 to scrape off a protrusion portion of the filling material that is higher than the upper plane of the taper hole platform 22, so that the dot-like filling material in the taper holes of the taper hole platform works together with the upper plane of the taper hole to form an array-point plane, which forms a composite material plane with the metal substrate. In this case, the 3D printed product is connected to the dot-like filling material in the composite material plane. In addition, the heating storage tank system uses the temperature controlled heating plate to heat the filling material in the storage tank and fuse it. Moreover, the platform lifting system controls the ascending and the descending of the taper hole platform 22 by controlling the stepper motor 24 to drive the platform lead screw 25 to rotate.

Further, in the processing apparatus disclosed in this embodiment of the present application, the stepper motor 24 is fixed at the outside of the storage tank 27; the platform lead screw 25 is connected to the stepper motor 25; the taper hole platform is connected to the platform lead screw; the rotation of the platform lead screw 25 drives the taper hole platform 22 to ascend or descend, controls a distance between the taper hole platform 22 and the storage tank 27, and controls the melted filling material to fill up the taper holes.

After printing of the 3D printed product is completed, the taper hole platform 22 is enabled to ascend by the rotation of the platform lead screw 25, so that the printed 3D printed product and the filling material in the taper hole are fractured and separated at a tapered vertex, thereby separating the 3D printed product from the taper hole platform 22.

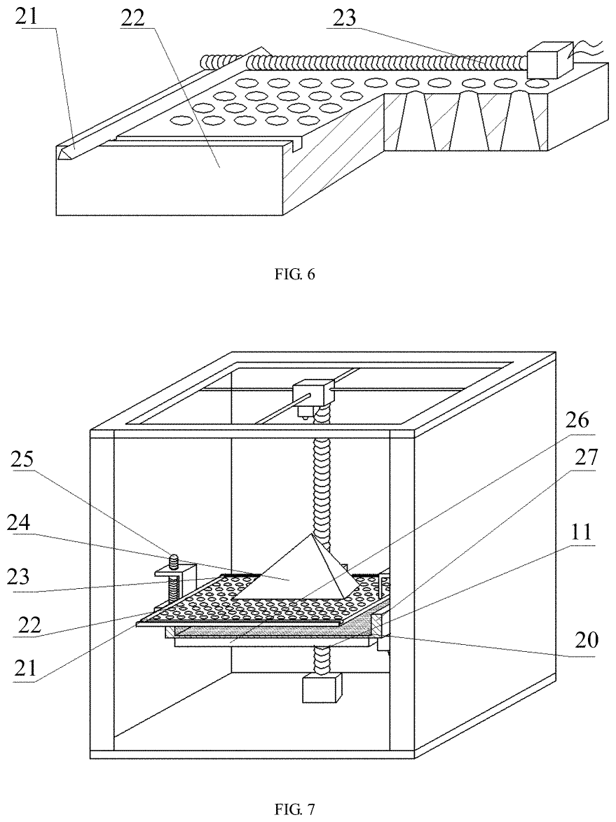

Refer to a schematic diagram of connection between a 3D printed product and a taper hole platform shown in FIG. 5, a partial schematic diagram of a scraper shown in FIG. 6, and a mounting schematic diagram of a taper hole platform and a 3D printer shown in FIG. 7, when the 3D printed product is printed by the processing apparatus disclosed in the embodiments of the present application, before the printing of the model of the 3D printed product, the stepper motor 24 in the platform lifting system may be first controlled to rotate to separate the taper hole platform 22 from the storage tank 27, and then a certain amount of the filling material 20 is placed into the storage tank 27. Subsequently, the temperature controlled heating plate 26 is started and continuously heats to a fuse point of the filling material 20, in order to make the filling material 20 fuse fully to be in a fused status. After that, the stepper motor 24 in the platform lifting system is controlled to drive the platform lead screw 25 to rotate, so that the taper hole platform 22 moves downward to contact with the melted filling material 24 filling material 20, and slightly presses the filling material 24 filling material 20 to embed the fused filling material 24 filling material 20 into the taper hole. The stepper motor 24 is stopped when the fused filling material 24 filling material 20 in each taper hole is flush with the upper plane of the taper hole platform 22. As shown in FIG. 6, the scraper 21 is driven to scrape off the protrusion portion of the filling material 24 filling material 20 that is higher than the upper plane of the taper hole platform 22, so that the dot-like filling material 24 filling material 20 in the taper holes forms a composite material plane with the upper plane of the taper holes. Further, as shown in FIG. 7, the 3D printing is started when a temperature of the temperature controlled heating plate 26 is kept between 60° C. and 70° C. The platform lifting system controls the stepper motor to drive the 3D printer as the platform lead screw rotates in the vertical direction, thereby controlling the entire taper hole platform to descend layer by layer according to a designated layer height. When printing of the baseboard is completed, that is, when two to three layers are printed and stacked, a power source of the temperature controlled heating plate 26 is turned off to stop heating, and the 3D printing is continued. During the printing process, the filling material is melted and bonded with the 3D printed product through the taper hole, and is connected to the taper hole platform 2, so as to prevent the 3D printed product from warping and being separated from the taper hole platform 22. Further, when printing of the baseboard of the 3D printed product is completed, the temperature controlled heating plate is not required to heat during printing of a second layer or a third layer. Therefore, a heating operation of the temperature controlled heating plate can be terminated for saving energy. In addition, after the printing is completed, the rotation of the platform lead screw 25 enables the taper hole platform 22 to ascend, so that the 3D printed product and the filling material in the taper hole are fractured and separated at a tapered vertex, thereby helping the 3D printed product be separated from the taper hole platform 22 after being molded.

According to the embodiments of the present application, a problem that the product is warped and deformed due to an excessive temperature difference between the product and an environment during a 3D printing process performed by an existing prototyping platform 10, particularly for printing a large-scale product, is effectively resolved by using a principle of bonding of polymer products in a fused status. Therefore, the embodiments of the present application have features of low energy consumption, simple operation, wide adaptability, small influence by environmental factors, and effective prevention of warpage of the model and the like. In addition, the design that the filling material in the taper hole is fractured and separated at a tapered vertex after the printing is completed, makes it easy for the 3D printed product to separate from the taper hole platform 22 after being molded. Thus it facilitates pickup of components, and doesn't require the use of the temperature controlled heating plate for heating all the time in the whole printing process, thereby consuming less energy.

Further, in the embodiments of the present application, heating of the temperature controlled heating plate 26 and driving of the stepper motor 24 are manually controlled, or may be controlled by a second control apparatus. Further, movements of the scraper lead screw 23 and the platform lead screw 25 can be controlled through the driving of the stepper motor 24. That is, the movements of the scraper lead screw 23 and the platform lead screw 25 can be controlled by the second control apparatus. The first control apparatus may be a terminal device having a control function, such as a computer and the like. In addition, the first control apparatus and the second control apparatus may be a same control apparatus, or may be different control apparatuses.

In addition, during the 3D printing, a material is usually stacked layer by layer after being fused, and the material is solidified to be molded after being cooled, to obtain the 3D printed product. In the prior art, an internal structure of the printed 3D printed product is formed by superposing mutually parallel layers, that is, each layer of the material is in a cube form and layers of the material are horizontally stacked layer by layer. In this case, there is at least one dimension among the three dimensional directions which is only firmly connected by a weak adhesion force between fused materials. Therefore, there is a problem that the 3D printed products in the prior art have a low tensile strength and a low shear strength. Moreover, the 3D printed products are highly susceptible to stress concentration when subjected to external forces, resulting in damage to the structure of the 3D printed products.

To resolve the problem in the prior art that the tensile strength and the shear strength of the 3D printed products are insufficient, the present application further discloses another embodiment. In this embodiment, a 3D printed product having a mortise and tenon shaped mechanical engagement structure is proposed. In case of the same amount of materials, the 3D printed product having the mortise and tenon shaped mechanical engagement structure proposed by this embodiment of the present application has higher tensile strength and shear strength. Therefore, the quality of the 3D printed product is better.

In this embodiment of the present application, there is a mortise and tenon shaped mechanical engagement structure between adjacent filaments of a printed 3D printed product.

Staggered plane units engage and stack with each other in a staggered manner to form an integral structure of the 3D printed product, wherein a mechanical engagement structure printed in one processing cycle is referred to as a staggered plane unit, and each staggered plane unit is a molding plane with regular concave-convex structures at a surface thereof. The filament refers to a filamentary raw material for manufacturing a craftwork. A material used during 3D printing is usually formed by stacking fused fuse layer by layer. The fuse may be referred to as the filament. That is, the 3D printed product is formed by multiple layers of filament.

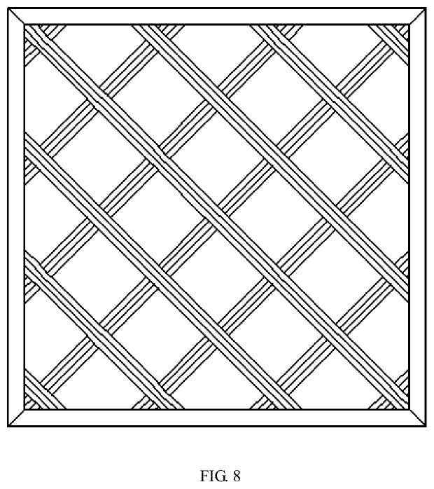

In addition, in this embodiment of the present application, printing duration of the 3D printed product includes a plurality of processing cycles. Since the 3D printed product is in a multi-layer structure, time required for printing each layer is referred to as a processing cycle. That is, processing of one layer of plane is completed in one processing cycle. In the prior art, planes processed in each processing cycle are parallel. However, in this embodiment of the present application, each plane is a staggered plane unit. That is, one staggered plane unit is completed in one processing cycle. FIG. 8 is a top view of each layer of staggered plane unit of a 3D printed product obtained according to an embodiment of the present application.

In this embodiment of the present application, during a process of printing the staggered plane unit, a protrusion-recess structure in the mortise and tenon shaped mechanical engagement structure is printed by adjusting movement of the 3D printer or the prototyping platform 10 in a vertical direction and by adjusting an amount of filament extruded by the 3D printer, thereby achieving the half-wire diameter printing. In addition, in this case, an extrusion amount of the filament may be properly reduced at an intersection at which the layers of stacked filaments are filled.

A structure constituted by various staggered plane units is a staggered laminated structure. In the staggered laminated structure, a height difference between same layers of adjacent filaments in a horizontal direction is half of a cable diameter, wherein, the cable diameter refers to a diameter of the filament used in the 3D printing process.

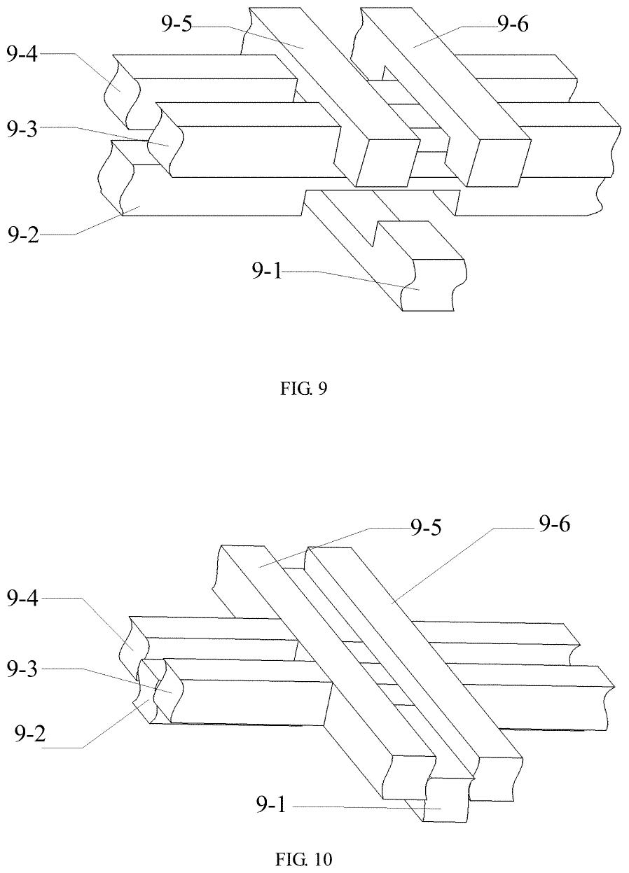

Specifically, in the 3D printing process, the fused filaments can be printed in a designated order, and each filament is lapped and deposited to form a staggered plane unit. The staggered plane units are superposed on each other, to form an overall mortise and tenon shaped mechanical engagement structure. FIG. 9 is a detailed exploded view of a mortise and tenon shaped mechanical engagement structure. FIG. 10 is a detailed constitutional diagram of a mortise and tenon shaped mechanical engagement structure.

In the embodiment of the present application, the mortise and tenon shaped mechanical engagement structure of the 3D printed product is a combination of a conventional Chinese mortise and tenon structure with an existing fused deposition process. According to the solution of the embodiment of the present application, an internal filling structure of the 3D printed product is converted from being formed by superposing parallel layers in the prior art into being formed by superposing mechanical mortise and tenon structures. In this way, there are more filling structures within the 3D printed product to withstand an external force together. This can disperse the external force withstanded by the 3D printed product to various engagement structures within the 3D printed product, thereby preventing the concentration of force on the 3D printed product, thus improving the strength of the 3D printed product.

To make clear the advantages of the present application, a 3D printed product built in an X-Y plane in a Cartesian coordinate system is used as an example below. In this coordinate system, when the 3D printed product suffers from a shearing force or an impact force parallel to the X-Y plane, due to there being a mortise and tenon shaped mechanical engagement structure between adjacent filaments in the embodiment of the present application, the mortise and tenon shaped mechanical engagement structure obscures a concept of layer-by-layer superposing, and a mortise and tenon shaped mechanical engagement structure manufactured in one processing cycle is referred to as a staggered plane unit. The entire 3D printed product is formed by the staggered plane units that engage with each other in a staggered manner and that are supposed on each other. Each staggered plane unit is a molding plane with regular concave-convex structures at a surface thereof. Due to this connection manner between filaments, when suffering from a shearing force or an impact force in a horizontal direction, the 3D printed product has an interlayer binding force to resist the shearing force or the impact force, and a concave-convex layer interface and a mechanically engaged internal filling structure may also disperse the suffered external force to the surrounding of a force-suffering point, so that all components of the 3D printed product resist the external force together, thereby preventing the single layer interface from being suffered from the force. Moreover, the mortise and tenon shaped mechanical engagement structure makes it not easy for the internal layers of the 3D printed product to slide relative to each other, thereby further ensuring the stability of the 3D printed product. In addition, when the 3D printed product suffers from a pulling force in the vertical direction, that is, the Z-axial direction, the mechanical engagement between the respective filaments enable force-suffering surfaces to change from mutually parallel horizontal surfaces into regular concave-convex layered interfaces, thus increasing contact surfaces between the fuses. In this case, in one aspect, adhesion forces between adjacent filaments can be enhanced; and in another aspect, the increased contact surfaces are all in the vertical direction, that is, a direction the same as that of the pulling force in the Z-axial direction. While the pulling force in the Z-axial direction is applied, frictional force generated between the filaments can act together with the adhesion force between the filaments, to resist the pulling force, and thereby achieve the strength enhancement effect of the 3D printed product.

In the embodiment of the present application, because the 3D printing is performed by using a staggered stacking method, there is a mortise and tenon shaped mechanical engagement structure between adjacent filaments of the 3D printed product, which obscures a concept of layer-by-layer 3D printing compared with the prior art. The 3D printed product is formed to be an integral structure by engaging the staggered plane units with each other in a staggered manner and superposing the staggered plane units on each other. A difference between adjacent heights of the staggered plane units in the horizontal direction is half of a filament diameter. That is to say, in the embodiment of the present application, by means of mechanical engagement, increasing an adhesion area between the filaments, or increasing an adhesion force between adjacent filaments, the inside of the 3D printed product is configured to be a mortise and tenon shaped mechanical engagement structure, thereby improving the strength of the 3D printed product.

Specifically, in the embodiment of the present application, during a process of printing the staggered plane unit, a protrusion-recess structure in the mortise and tenon shaped mechanical engagement structure is printed by adjusting the movement of the 3D printer or the prototyping platform 10 in the vertical direction (that is, the Z-axis) through the three-dimensional movement module 11, and by adjusting an amount of fuses extruded by the 3D printer, thereby achieving the half-wire diameter printing. Moreover, in this case, the protrusion-recess structure in the mortise and tenon shaped mechanical engagement structure is printed in this manner.

To make clear the printing process in the embodiment of the present application, an example is disclosed in the present application. In the example, refer to the detailed exploded view of the mortise and tenon shaped mechanical engagement structure shown in FIG. 9 and the detailed constitutional diagram of the mortise and tenon shaped mechanical engagement structure shown in FIG. 10, in the 3D printing process, one staggered plane unit can be printed in an order of reference numbers of 9-1, 9-2, 9-3, 9-4, 9-5, and 9-6. Specifically, firstly, all filaments with the reference number of 9-1 in the staggered plane unit are printed, and the 3D printer first moves downward and then slightly moves upward for a half-cable diameter in the vertical direction (that is, the Z-axis) at a filling intersection. Subsequently, the 3D printer rotates for 90 degrees to print filaments with the reference number of 9-2, and an extrusion amount of the filament is properly reduced at the filling intersection. Furthermore, the 3D printer moves upward for a half-wire diameter in the vertical direction (that is, the Z-axis) to print filaments with the reference number of 9-3. When printing to the filling intersection, the 3D printer first moves downward and then slightly moves upward for a half cable diameter in the vertical direction (that is, the Z-axis. Moreover, the extrusion amount of the filament is properly reduced at the filling intersection. Subsequently, filaments with the reference number of 9-4 are printed. During this process, when printing to the filling intersection, the 3D printer first moves downward and then slightly moves upward for a half cable diameter in the vertical direction (that is, the Z-axis). Moreover, the extrusion amount of the filament is properly reduced at the filling intersection, to finish the printing of the filaments numbered 9-4. Subsequently, the 3D printer rotates for 90 degrees to start printing the filaments with the reference numbers of 9-5 and 9-6, and during the process of printing the two filaments, the extrusion amount of the filament is properly reduced at the filling intersection. Hereto, the printing of a single staggered plane unit formed by the filaments with the reference numbers of 9-1 to 9-6 are completed.

In addition, in the above example, the staggered plane unit may be printed by adjusting the movement of the 3D printer. The movement of the 3D printer may be adjusted by the platform lead screw. In this case, the platform lead screw is connected to the 3D printer. When the 3D printer needs to be adjusted, the stepper motor is driven, and the platform lead screw drives the 3D printer to move under the control of the stepper motor.

Alternatively, the staggered plane unit may be printed by adjusting the movement of the prototyping platform 10. The movement of the prototyping platform 10 may be adjusted by the three-dimensional movement module 11. The prototyping platform 10 is a support platform of the 3D printed product, and the adjustment of the movement of the prototyping platform 10 is achieved by adjusting the three-dimensional movement module 11.

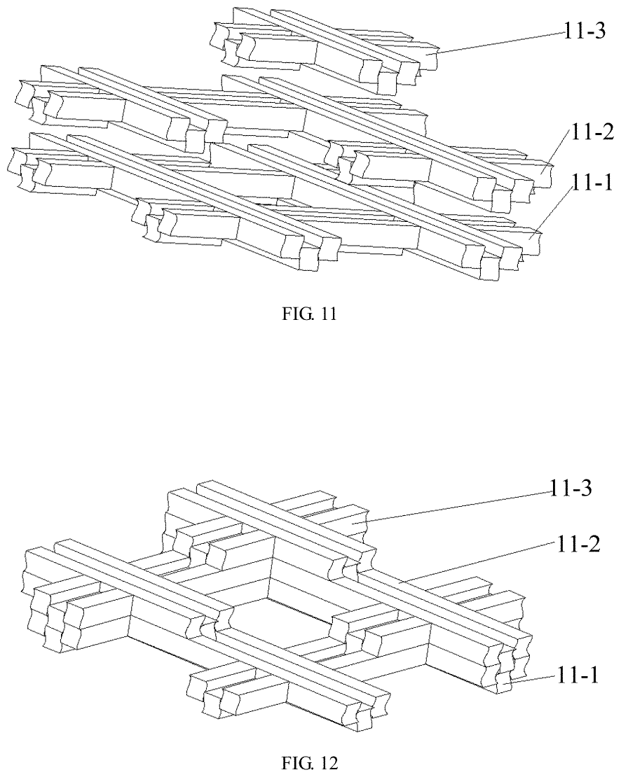

According to the above method, the staggered plane units are successively printed, and the staggered plane units are superposed on each other to form the integral structure of the 3D printed product. FIG. 11 is an exploded view of combination of each staggered plane unit, and FIG. 12 is a combined diagram of combination of each staggered plane unit. Referring to FIG. 11 and FIG. 12, 11-1 represents a staggered plane unit at an n^{th} layer, 11-2 represents a staggered plane unit at a (n+1)^{th} layer, and 11-3 represents a staggered plane unit at a (n+2)^{th} layer.

In addition, since the fused deposition technology is a bottom-up stacking and molding technology, when a cantilever structure needs to be printed, a support structure needs to be printed in advance below the cantilever structure to prevent the cantilever structure from collapsing due to gravity during printing, and the support structure is removed after the printing of the cantilever structure is completed. However, this may leave traces of the support structure on a surface of the cantilever structure, resulting in relatively worse surface quality of the 3D printed product. Moreover, the support structure is usually a plastic consumable, which will be abandoned, so it is non-environment friendly.

To resolve this problem, the present application further discloses another embodiment, which uses the Maxwell's electromagnetic theory to change a magnetic moment direction of a magnetic substance (such as iron, cobalt, nickel, or the like) and coordinate with the gravity, so as to help a cantilever structure, which is made of a polymer-based metal composite material, to be printed and molded in a suspension manner. Moreover, when there is no need to print the cantilever structure, the solution of this embodiment may be used to enhance a contact force between a lower surface of the 3D printed product and the prototyping platform 10, thereby avoiding warpage and deformation of the 3D printed product.

In the embodiment of the present application, the material applied in the printing process of the 3D printer is a polymer-based magnetic metal composite material. The polymer-based magnetic metal composite material is a material formed by melt-blending magnetic material fibers or powder and a polymer material. Therefore, the magnetic material fibers or powder and the polymer material are usually melt-blended before the 3D printing, and then are extruded by the 3D printer as a filamentary consumable that is required for fused deposition and molding, to serve as a standby material in the 3D printing process.

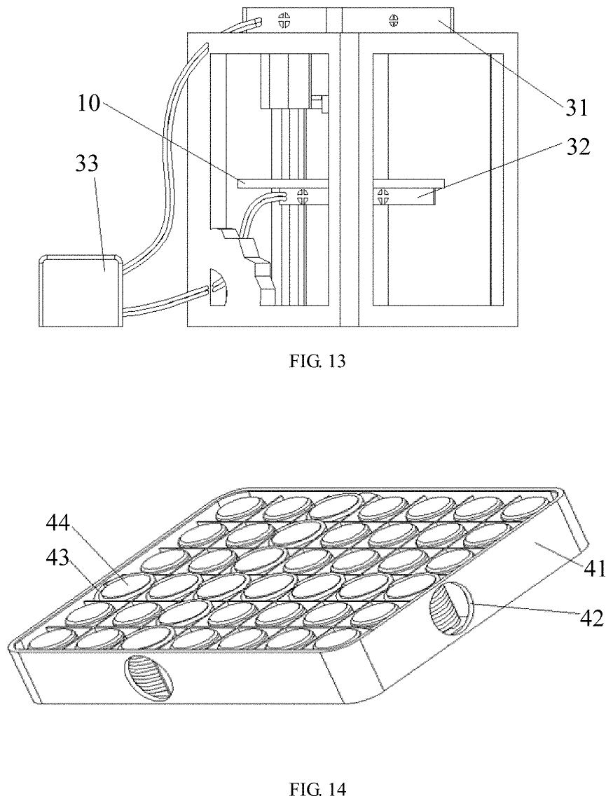

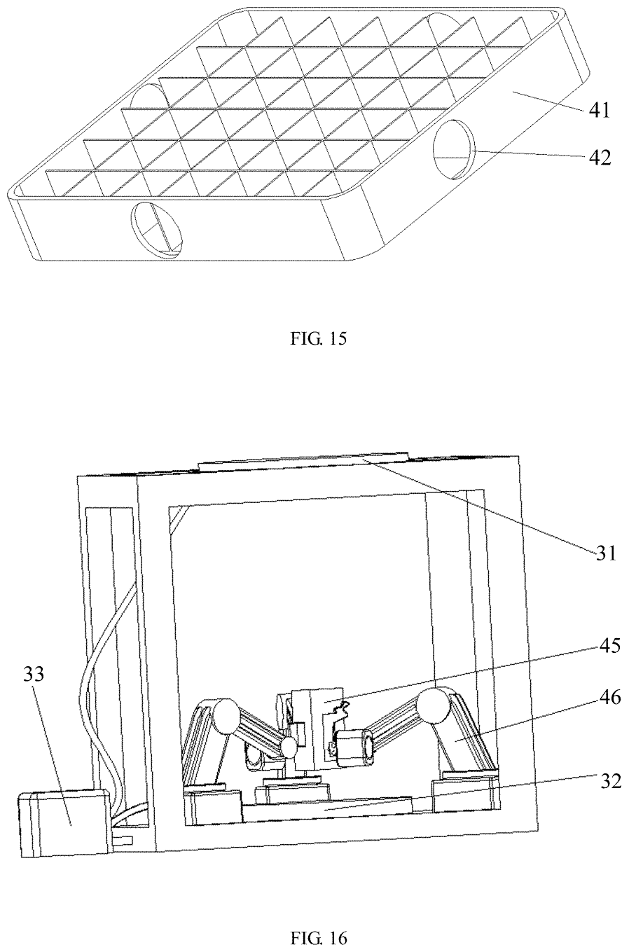

Referring to a schematic structural diagram of a processing apparatus shown in FIG. 13, a schematic diagram of a magnetism creation platform shown in FIG. 14, a schematic diagram of a wire bushing box of a magnetism creation platform shown in FIG. 15, and a scenario schematic diagram of printing a plurality of suspending mechanical arms shown in FIG. 16, in the processing apparatus disclosed in the embodiments of the present application, a material of the prototyping platform 10 is a high magnetic permeability material, and the processing apparatus includes a magnetic assistant system and a control system. The magnetic assistant system includes a wire bushing box 41, a electromagnetic coil 43, an iron core 44, and a heat dissipation device. The control system includes a 3D printer control system, a magnetic field control system, and a magnetic isolation box 33.

The 3D printer control system and the magnetic field control system are disposed within the magnetic isolation box 33, to prevent magnetic fields of the 3D printer control system and the magnetic field control system from interfering with the 3D printer control system and the magnetic field control system. Moreover, conducting wires of the 3D printer control system and the magnetic field control system are migrated from internal of the magnetic isolation box 33, and the magnetic isolation box 33 is disposed at one side of the 3D printer.

The wire bushing box includes an upper housing, a lower housing, a side housing, and an internal isolation zone. The side housing is made of a low magnetic permeability material. The upper housing and the lower housing are made of high magnetic permeability materials. The internal isolation zone is in a rectangular grid structure, and a side length of a grid in the rectangular grid structure is consistent with an outer diameter of the electromagnetic coil. An electromagnet constituted by the electromagnetic coil and the iron core is disposed within a rectangular grid constituted by the internal isolation zone, and the internal isolation zone is made of a material having a low magnetic permeability and electric field isolation effects.

The internal isolation zone is made of a material having a low magnetic permeability and electric field isolation effects, such as copper. Meanwhile, during a working process, the internal isolation zone needs to be grounded, to reduce interference of a electromagnetic coil on an adjacent electromagnetic coil.

The wire bushing box forms a magnetism creation platform. The magnetism creation platform includes an upper-layer magnetism creation platform 31 and a lower-layer magnetism creation platform 32, wherein, the upper-layer magnetism creation platform 31 is disposed at a top portion of a 3D printer, and the lower-layer magnetism creation platform 32 is mounted below the prototyping platform 10. The lower-layer magnetism creation platform 32 moves in the vertical direction (that is, the Z-axis) along with the prototyping platform 10, and the upper-layer magnetism creation platform is parallel to the lower-layer magnetism creation platform.

The magnetic field control system is configured to control a current of the electromagnetic coil and an operation of the heat dissipation device. Moreover, the magnetic field control system monitors an operating status of the 3D printer, controls on or off of the current and a value of the current of the electromagnetic coil based on the operating status of the 3D printer, and controls the operation of the heat dissipation device based on a temperature in the wire bushing box, so that the temperature in the wire bushing box is kept within a reasonable range, until the magnetism creation platform is no longer used during this printing process and a temperature within the magnetism creation platform falls to a room temperature.

Specifically, the magnetic field control system monitors the operating status of the 3D printer at any time. The operating status of the 3D printer includes a printing position and an extrusion amount of the fused material. Based on the operating status of the 3D printer, the magnetic field control system controls on or off of a current of a electromagnetic coil and the value of the current supplied to the electromagnetic coil, and the electromagnetic coil is located at a corresponding position of the magnetism creation platform covered by a vertical projection of the fused material extruded by the 3D printer.

During the 3D printing process, when the 3D printer fuses and extrudes the material and the material is in contact with the prototyping platform 10, the magnetic field control system is configured to detect a contact surface area of the material with the prototyping platform 10, and apply a current to a electromagnetic coil in a corresponding area of the lower-layer magnetism creation platform that is a vertical projection of the contact surface area, so that a magnetic metal material in the material is attracted by a magnetic force of the lower-layer magnetism creation platform. In this case, it can be ensured that a bottom surface of the 3D printed product is in close contact with the prototyping platform 10, thereby avoiding warpage and deformation of the 3D printed product.

When the 3D printer control system determines that a cantilever structure needs to be printed, the magnetic field control system is configured to control the lower-layer magnetism creation platform to stop working. The magnetic field control system applies a current to a electromagnetic coil in a corresponding area of the upper-layer magnetism creation platform that is a vertical projection of the cantilever structure, and a value of the applied current is in a positive correlation with an amount of the material that is extruded by the 3D printer under control of the 3D printer control system, so that a melted material of the cantilever structure extruded at a nozzle of the 3D printer is suspended in the air, and is cooled and solidified during the suspending process, thereby achieving the printing of the cantilever structure without support.

When the printing of the cantilever structure is completed, the upper-layer magnetism creation platform stops working, while the lower-layer magnetism creation platform continues to work, to firmly attract the 3D printed product onto the prototyping platform 10.

Compared with a conventional 3D printing technology, the solution of the embodiment of the present application can optimize a 3D printing process of a cantilever structure made of a polymer-based metal composite material, to reduce building processes of a support structure and reduce consumables required for building the support structure; and improve the printed surface quality of the cantilever structure of the 3D printed product, to avoid damages to the surface in a process of removing support materials, and to effectively prevent the 3D printed product from warping.

Further, according to the solution of the embodiment of the present application, by a material blended with a polymer material and a magnetic substance, suspending 3D printing can be realized, and simultaneous extrusion, bonding, and molding work of a plurality of mechanical arms 46 can be realized, thus, the 3D printing can be realized without a horizontal prototyping platform 10. During the molding process, magnetic strength of the upper-layer magnetism creation platform can be adjusted by changing a value of the current of the electromagnetic coil corresponding to the upper-layer magnetism creation platform in an area covered by a vertical and upward projection of a consumable extruded by the mechanical arm, so as to keep the printed consumable stably suspending in the art until the consumable is cooled and solidified, thereby obtaining a suspending 3D printed product. According to this method, a plurality of mechanical arms for printing and extruding may be allowed to work at the same time, and extrusion, bonding, and molding work are performed in different directions. In this way, a disadvantage of anisotropy of triaxial processing in the conventional Cartesian coordinate system is overcome, thereby realizing a technology capable of completely suspending printing and molding from different dimensions selected according to performance requirements of different positions, and improving an efficiency of printing the 3D printed product.

In addition, in the embodiment of the present application, the low magnetic permeability material applied to the side housing is usually aluminum alloy, and the high magnetic permeability materials applied to the upper housing and the lower housing are usually industrial pure iron.

The heat dissipation device includes fans that are mounted at a front surface, a back surface, a left surface, and a right surface of the wire bushing box and are symmetrical with each other, to prevent electromagnetic devices from working to form a large amount of thermal eddy currents, and the heat dissipation speed is increased. The magnetic field control system controls a working speed of the fan based on the temperature in the wire bushing box.

The magnetic isolation box is made of a low magnetic permeability material, and the magnetic isolation box completely wraps the 3D printer control system and the magnetic field control system.

Correspondingly, the present application further discloses a 3D printing technology-based processing method. The processing method is applied to the above 3D printing technology-based processing apparatus, and includes the following steps:
obtaining a 3D printed product by using the 3D printer at a model designing stage of the 3D printed product according to requirements on strength of the 3D printed product, wherein, a plurality of blind holes or passageways are disposed along a vertical direction in the 3D printed product;
driving, by the three-dimensional movement module 11, the prototyping platform 10 to move to be right below the micro injection molding machine 2 and move upward, so that an upper surface of the 3D printed product is kept close to a rubber cushion below the connector 6; and then rotating the dual-channel one-way valve 5 within the connector 6 to open the vacuumizer channel and close the injection path, wherein, the vacuumizer 3 works to exhaust air within the blind hole or the passageway of the 3D printed product through the blind hole opening or the passageway opening, to form vacuum in the blind hole or the passageway; and
rotating the dual-channel one-way valve 5 again to close the vacuumizer channel and open the injection path, wherein, the micro injection molding machine 2 injects a melted polymer filler into the blind hole or the passageway.

According to the solutions disclosed in the embodiments of the present application, the fused polymer filler can be filled in the blind hole or the passageway of the 3D printed product, to improve overall strength of the 3D printed product.

Further, when the processing apparatus includes the taper hole prototyping platform 10 system, the heating storage tank system, and the platform lifting system according to the above embodiments, the processing method further includes:
transferring heat to the storage tank by using the temperature controlled heating plate to fuse the filling material in the storage tank, and controlling, through a rotation and a downward movement of the platform lead screw, the taper hole platform to move downward and become in contact with the filling material melted in the storage tank, to embed the melted filling material into the taper hole;
driving, by the scraper lead screw, the scraper to scrape off a protrusion portion of the filling material that is higher than the upper plane of the taper hole platform, so that the dot-like filling material in the taper hole of the taper hole platform and an upper plane of the taper hole form an array-point plane, wherein the array-point plane and the metal substrate form a composite material plane; and
after printing of the 3D printed product is completed, enabling the taper hole platform to ascended through the rotation of the platform lead screw, so that the printed 3D printed product and the filling material in the taper hole are fractured and separated at a tapered vertex, thereby separating the 3D printed product from the taper hole platform.

According to the method disclosed in the embodiments of the present application, a problem, during a 3D printing process, particularly a process of printing a large-scale product by the existing prototyping platform 10, that warpage and deformations occur to the product due to an excessive temperature difference between the product and an environment is effectively resolved by using a principle that a polymer product is bonded in a fused status. In addition, after the printing is completed, the filling material in the taper hole is fractured and separated at a tapered vertex, helping the 3D printed product be separated from the taper hole platform after being molded. This facilitates pickup of components, and there is no need to heat the temperature controlled heating plate in the whole printing process, thereby consuming less energy.

Further, when the processing apparatus includes the magnetic assistant system and the control system according to the above embodiments, the processing method further includes:
turning on the heat dissipation device by the magnetic field control system, until the magnetism creation platform is no longer used during this printing process and the temperature within the magnetism creation platform falls to the room temperature;
during the 3D printing process, when the 3D printer fuses and extrudes a material and the material is in contact with the prototyping platform 10, detecting, by the magnetic field control system, a contact surface area of the material with the prototyping platform 10, and applying a current to a electromagnetic coil in a corresponding area of the lower-layer magnetism creation platform that is a vertical projection of the contact surface area, so that a magnetic metal material in the material is attracted by a magnetic force of the lower-layer magnetism creation platform;
when the 3D printer control system determines that a cantilever structure needs to be printed, controlling, by the magnetic field control system, the lower-layer magnetism creation platform to stop working, wherein, the magnetic field control system applies a current to a electromagnetic coil in a corresponding area of the upper-layer magnetism creation platform that is a vertical projection of the cantilever structure, and a value of the applied current is in a positive correlation with an amount of the material that is extruded by the 3D printer under the control of the 3D printer control system, so that a fused material of the cantilever structure extruded at a nozzle of the 3D printer is suspended in the air, and is cooled and solidified during the suspending process, thereby achieving the printing of the cantilever structure without support; and
when printing of the cantilever structure is completed, enabling the upper-layer magnetism creation platform to stop working, and enabling the lower-layer magnetism creation platform to continue to work, to firmly magnetically attract the 3D printed product onto the prototyping platform 10.

The method disclosed in the embodiments of the present application can optimize a 3D printing process of a cantilever structure made of a polymer-based metal composite material, to reduce building processes of a support structure and reduce consumables required for building the support structure; and improve the printed surface quality of the cantilever structure of the 3D printed product, to avoid damages to the surface in a process of removing support materials, and to effectively prevent the 3D printed product from warping.

It should be understood that in various embodiments of the present application, a sequence number of each process does not mean a sequential order for execution. An execution sequence of each process is determined based on functions and internal logic of the process, and should not be any limitation on the implementation processes of the embodiments of the present application.

The above embodiments may be implemented completely or partially by software, hardware, firmware, or any combination thereof. When a software program is used to implement the embodiments, the embodiments may be implemented completely or partially in a form of a computer program product. The computer program product includes one or more computer instructions. When the computer program instructions are loaded and executed on a computer, the procedure or functions according to the embodiments of the present application are completely or partially generated. The computer may be a general-purpose computer, a special-purpose computer, a computer network, or other programmable apparatus. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any available medium accessible by the computer, or a data storage device, such as a server or a data center, integrating one or more available media. The available medium may be a magnetic medium (for example, a soft disk, a hard disk, or a magnetic tape), an optical medium (for example, a DVD), a semiconductor medium (for example, a solid state drive, (SSD)), or the like.

Various parts of this specification are all described in a progressive manner. For same or similar parts between the embodiments, reference may be made to each other. For each embodiment, emphasis is put on differences of this embodiment from other embodiments. In particular, for apparatus and system embodiments, the description is relatively simple as it is substantially similar to the method embodiment, and the relevant portions can be found in the description of the method embodiments.

Although preferred embodiments of the present application are described, a person skilled in the art may make additional changes and modifications to these embodiments once learns a basic inventive concept. Therefore, the appended claims are intended to be explained as including the preferred embodiments and all changes and modifications that fall within the scope of the present application.

For same or similar parts between the embodiments in this specification, reference may be made to each other. In particular, for apparatus and system embodiments, the description is relatively simple as it is substantially similar to the method embodiment, and the relevant portions can be found in the description of the method embodiments.

The embodiments of the invention described above are not intended to limit the scope of the invention.

1. A 3D printing technology-based processing apparatus, comprising:
a frame, an injection unit, and a molding unit, wherein
the injection unit comprises a micro injection molding machine, a vacuumizer, a connector, a dual-channel one-way valve, and a rubber gasket;
the molding unit comprises a fused deposition modeling extruder, a prototyping platform, and a three-dimensional movement module;
a die of the micro injection molding machine is connected to a 3D printed product by using the connector, and the dual-channel one-way valve controls opening and closing of an vacuumizer channel and an injection path in the connector;
the prototyping platform is mounted on the three-dimensional movement module;
the micro injection molding machine and the fused deposition modeling extruder are fixedly mounted on the frame side by side; and
the fused deposition modeling extruder comprises a heating nozzle, and the fused deposition modeling extruder feeds a polymer material filament into the heating nozzle by means that gears rotate in opposite directions to engage, and fuses, plasticizes, and extrudes the polymer material filament by using the heating nozzle, wherein extruded fuses enter, under the three-dimensional movement of the prototyping platform, a blind hole or a passageway of the 3D printed product for stack molding.

2. The processing apparatus according to claim 1, wherein
the connector is a tapered connector, and is mounted at the die of the micro injection molding machine; and
the outside of the connector is winded with a heating ring, a lower end of the connector is mounted with the rubber gasket, an interior of the connector is a three-way structure, an upper end of the connector is connected to the die of the micro injection molding machine, a lower end of the connector is connected to a blind hole opening or a passageway opening of the 3D printed product, a side opening of the connector is connected to the vacuumizer, and the dual-channel one-way valve is disposed within the connector.

3. The processing apparatus according to claim 1, further comprising:
a taper hole prototyping platform system, a heating storage tank system, and a platform lifting system, wherein
the taper hole prototyping platform system comprises a metal substrate, a scraper lead screw, and a scraper, the heating storage tank system comprises a temperature controlled heating plate and a storage tank, and the platform lifting system comprises a stepper motor and a platform lead screw;
a plurality of taper holes arranged in an array are machined in the metal substrate, the metal substrate and the prototyping platform collectively constitutes a taper hole platform, the taper hole platform is connected to the storage tank by using the platform lead screw and is mounted above the storage tank, the taper hole platform ascends or descends and is leveled in a vertical direction, and the taper hole platform is a support platform of the 3D printed product;
the scraper is connected to the taper hole platform by using a guide rail, and the scraper moves in a horizontal direction under control of the scraper lead screw;
the storage tank is connected to a 3D printer by using the three-dimensional movement module, and both the storage tank and the taper hole platform are enabled to ascend or descend in the vertical direction through movement of the three-dimensional movement module;
the temperature controlled heating plate is pasted at the bottom of the storage tank, and the temperature controlled heating plate is heated by an internal resistant of itself, and transfers heat to the storage tank, to melt the filling material in the storage tank;
the platform lifting system is fixed at the left and right of the storage tank, and the platform lifting system controls the ascending and descending of the taper hole platform relative to the storage tank by a stepper motor driving the platform lead screw to rotate;
when the taper hole platform moves into the storage tank under the rotation of the platform lead screw, the taper hole platform squeezes the filling material melted in the storage tank to fill up the taper hole in the taper hole platform, and the filling material that fills up the taper hole is flush with the taper hole platform, so that the 3D printed product and the filling material in the taper hole of the taper hole platform are melt and adhere as an integral; and
the scraper is mounted at an upper surface of the taper hole platform, and moves under the control of the scraper lead screw and the stepper motor, a working surface of the scraper is flush with an upper plane of the taper hole platform, and when the filling material in the storage tank melts and fills up into the taper hole, the melted material and the metal substrate are in a same plane under an action of the scraper, to serve as a fixed joint face of a print model.

4. The processing apparatus according to claim 3, wherein
the stepper motor is fixed at the outside of the storage tank, the platform lead screw is connected with the stepper motor, the taper hole platform is connected with the platform lead screw, and the platform lead screw rotates to drive the taper hole platform to ascend or descend, control the distance between the taper hole platform and the storage tank, and control the melted filling material to fill up the taper hole; and
after printing of the 3D printed product is completed, the taper hole platform is enabled to ascend through the rotation of the platform lead screw, so that the 3D printed product and the filling material in the taper hole are fractured and separated at a tapered vertex, thereby separating the 3D printed product from the taper hole platform.

5. The processing apparatus according to claim 1, wherein
there is a mortise and tenon shaped mechanical engagement structure between adjacent filaments of a 3D printed product; and
various staggered plane units engage with each other in a staggered manner and are superposed on each other to form an integral structure of the 3D printed product, wherein a mechanical engagement structure printed in one processing cycle is referred to as a staggered plane unit, and each staggered plane unit is a molding plane with regular concave-convex structures at a surface thereof.

6. The processing apparatus according to claim 5, wherein
during a process of printing the staggered plane unit, a movement of the 3D printer or the prototyping platform in a vertical direction is adjusted by using the three-dimensional movement module, and a protrusion-recess structure in the mortise and tenon shaped mechanical engagement structure is printed by adjusting an amount of fuses extruded by the 3D printer, to achieve an half-wire diameter printing; and
a structure constituted by the staggered plane units is a staggered laminated structure, and in the staggered laminated structure, a height difference between same layers of adjacent filaments in a horizontal direction is half of a wire diameter.

7. The processing apparatus according to claim 1, wherein
a material of the prototyping platform is a high magnetic permeability material; and
the processing apparatus further comprises:
a magnetic assistant system and a control system, wherein
the magnetic assistant system comprises a wire bushing box, an electromagnetic coil, an iron core, and a heat dissipation device, and the control system comprises a 3D printer control system, a magnetic field control system, and a magnetic isolation box;
the 3D printer control system and the magnetic field control system are disposed within the magnetic isolation box, to prevent magnetic fields of the 3D printer control system and the magnetic field control system from interfering with the control system, conducting wires of the 3D printer control system and the magnetic field control system are migrated from internal of the magnetic isolation box, and the magnetic isolation box is disposed at one side of the 3D printer;
the wire bushing box comprises an upper housing, a lower housing, a side housing, and an internal isolation zone, wherein the side housing is made of a low magnetic permeability material, the upper housing and the lower housing are made of high magnetic permeability materials, the internal isolation zone is in a rectangular grid structure, a side length of a grid in the rectangular grid structure is consistent with an outer diameter of the electromagnetic coil, an electromagnet constituted by the electromagnetic coil and the iron core is disposed within a rectangular grid constituted by the internal isolation zone, and the internal isolation zone is made of a material having a low magnetic permeability and an electric field isolation effect;
the wire bushing box forms a magnetism creation platform, the magnetism creation platform comprises an upper-layer magnetism creation platform and a lower-layer magnetism creation platform, the upper-layer magnetism creation platform is disposed at a top portion of a 3D printer, the lower-layer magnetism creation platform is mounted at the bottom of the prototyping platform, the lower-layer magnetism creation platform moves in a vertical direction along with the prototyping platform, and the upper-layer magnetism creation platform is parallel to the lower-layer magnetism creation platform;
the magnetic field control system is configured to control a current of the electromagnetic coil and an operation of the heat dissipation device, and the magnetic field control system monitors an operating status of the 3D printer, controls on or off of the current of the electromagnetic coil and a value of the current of the electromagnetic coil based on the operating status of the 3D printer, and controls the operation of the heat dissipation device based on a temperature in the wire bushing box, so that the temperature in the wire bushing box is kept within a reasonable range, until the magnetism creation platform is no longer used during this printing process and a temperature within the magnetism creation platform falls to a room temperature;
during a 3D printing process, when the 3D printer melts and extrudes a material and the material is in contact with the prototyping platform, the magnetic field control system is configured to detect a contact surface area of the material with the prototyping platform, and apply a current to an electromagnetic coil in a corresponding area of the lower-layer magnetism creation platform that is a vertical projection of the contact surface area, so that a magnetic metal material in the material is attracted by a magnetic force on the lower-layer magnetism creation platform;
when the 3D printer control system determines that a cantilever structure needs to be printed, the magnetic field control system is configured to control the lower-layer magnetism creation platform to stop working, the magnetic field control system applies a current to an electromagnetic coil in a corresponding area of the upper-layer magnetism creation platform that is a vertical projection of the cantilever structure, and a value of the applied current is in a positive correlation with an amount of the material that is extruded by the 3D printer under control of the 3D printer control system, so that a melted material of the cantilever structure extruded at a nozzle of the 3D printer is suspended in the air, and is cooled and solidified during the suspending process, thereby achieving the printing of the cantilever structure without support; and
when printing of the cantilever structure is completed, the upper-layer magnetism creation platform stops working, and the lower-layer magnetism creation platform continues to work, to firmly attract the 3D printed product onto the prototyping platform.

8. The processing apparatus according to claim 7, wherein
the low magnetic permeability material applied to the side housing is aluminum alloy, and the high magnetic permeability materials applied to the upper housing and the lower housing are industrial pure iron;
the heat dissipation device comprises fans, the fans are mounted at a front surface, a back surface, a left surface, and a right surface of the wire bushing box and are symmetrical with each other, and the magnetic field control system controls a working speed of the fan based on the temperature in the wire bushing box; and
the magnetic isolation box is made of a low magnetic permeability material, and the magnetic isolation box completely wraps the 3D printer control system and the magnetic field control system.

9. A 3D printing technology-based processing method, applied to the 3D printing technology-based processing apparatus according to claim 1, and comprising:
obtaining a 3D printed product by using the 3D printer at a model designing stage of the 3D printed product according to requirements on strength of the 3D printed product, wherein a plurality of blind holes or passageways are disposed along a vertical direction in the 3D printed product;
driving, by the three-dimensional movement module, the prototyping platform to move to be right below the micro injection molding machine and move upward, so that an upper surface of the 3D printed product is kept close to a rubber cushion below the connector; and then rotating the dual-channel one-way valve within the connector to open the vacuumizer channel and close the injection path, wherein the vacuumizer works to exhaust air within the blind hole or the passageway of the 3D printed product through the blind hole opening or the passageway opening, to form vacuum in the blind hole or the passageway; and
rotating the dual-channel one-way valve again to close the vacuumizer channel and open the injection path, wherein the micro injection molding machine injects a melted polymer into the blind hole or the passageway.

10. The processing method according to claim 9, wherein the processing apparatus comprises the taper hole prototyping platform system, the heating storage tank system, and the platform lifting system,
wherein, the taper hole prototyping platform system comprises a metal substrate, a scraper lead screw, and a scraper, the heating storage tank system comprises a temperature controlled heating plate and a storage tank, and the platform lifting system comprises a stepper motor and a platform lead screw;
a plurality of taper holes arranged in an array are machined in the metal substrate, the metal substrate and the prototyping platform collectively constitutes a taper hole platform, the taper hole platform is connected to the storage tank by using the platform lead screw and is mounted above the storage tank, the taper hole platform ascends or descends and is leveled in a vertical direction, and the taper hole platform is a support platform of the 3D printed product;
the scraper is connected to the taper hole platform by using a guide rail, and the scraper moves in a horizontal direction under control of the scraper lead screw;
the storage tank is connected to a 3D printer by using the three-dimensional movement module, and both the storage tank and the taper hole platform are enabled to ascend or descend in the vertical direction through movement of the three-dimensional movement module;
the temperature controlled heating plate is pasted at the bottom of the storage tank, and the temperature controlled heating plate is heated by an internal resistant of itself, and transfers heat to the storage tank, to melt the filling material in the storage tank;
the platform lifting system is fixed at the left and right of the storage tank, and the platform lifting system controls the ascending and descending of the taper hole platform relative to the storage tank by a stepper motor driving the platform lead screw to rotate;
when the taper hole platform moves into the storage tank under the rotation of the platform lead screw, the taper hole platform squeezes the filling material melted in the storage tank to fill up the taper hole in the taper hole platform, and the filling material that fills up the taper hole is flush with the taper hole platform, so that the 3D printed product and the filling material in the taper hole of the taper hole platform are melt and adhere as an integral; and
the scraper is mounted at an upper surface of the taper hole platform, and moves under the control of the scraper lead screw and the stepper motor, a working surface of the scraper is flush with an upper plane of the taper hole platform, and when the filling material in the storage tank melts and fills up into the taper hole, the melted material and the metal substrate are in a same plane under an action of the scraper, to serve as a fixed joint face of a print model,
the processing method further comprises:
transferring heat to the storage tank by using the temperature controlled heating plate to melt the filling material in the storage tank, and controlling, through a rotation of the platform lead screw, the taper hole platform to move downward and become in contact with the filling material melted in the storage tank, to embed the melted filling material into the taper hole;
driving, by the scraper lead screw, the scraper to scrape off a protrusion portion of the filling material that is higher than the upper plane of the taper hole platform, so that the dot-like filling material in the taper hole of the taper hole platform and an upper plane of the taper hole form an array-point plane, wherein the array-point plane and the metal substrate become a composite material plane; and
after printing of the 3D printed product is completed, enabling the taper hole platform to ascended through the rotation of the platform lead screw, so that the printed 3D printed product and the filling material in the taper hole are fractured and separated at a tapered vertex, thereby separating the 3D printed product from the taper hole platform.

11. A 3D printing technology-based processing method, applied to the 3D printing technology-based processing apparatus according to claim 7, and comprising:
obtaining a 3D printed product by using the 3D printer at a model designing stage of the 3D printed product according to requirements on strength of the 3D printed product, wherein a plurality of blind holes or passageways are disposed along a vertical direction in the 3D printed product;
driving, by the three-dimensional movement module, the prototyping platform to move to be right below the micro injection molding machine and move upward, so that an upper surface of the 3D printed product is kept close to a rubber cushion below the connector; and then rotating the dual-channel one-way valve within the connector to open the vacuumizer channel and close the injection path, wherein the vacuumizer works to exhaust air within the blind hole or the passageway of the 3D printed product through the blind hole opening or the passageway opening, to form vacuum in the blind hole or the passageway;
rotating the dual-channel one-way valve again to close the vacuumizer channel and open the injection path, wherein the micro injection molding machine infects a melted polymer into the blind hole or the passageway;
turning on the heat dissipation device by the magnetic field control system, until the magnetism creation platform is no longer used during this printing process and the temperature within the magnetism creation platform falls to the room temperature;
during the 3D printing process, when the 3D printer melts and extrudes a material and the material is in contact with the prototyping platform, detecting, by the magnetic field control system, a contact surface area of the material with the prototyping platform, and applying a current to an electromagnetic coil in a corresponding area of the lower-layer magnetism creation platform that is a vertical projection of the contact surface area, so that a magnetic metal material in the material is attracted by a magnetic force in the lower-layer magnetism creation platform;
when the 3D printer control system determines that a cantilever structure needs to be printed, controlling, by the magnetic field control system, the lower-layer magnetism creation platform to stop working, wherein the magnetic field control system applies a current to an electromagnetic coil in a corresponding area of the upper-layer magnetism creation platform that is a vertical projection of the cantilever structure, and a value of the applied current is in a positive correlation with an amount of the material that is extruded by the 3D printer under the control of the 3D printer control system, so that a melted material of the cantilever structure extruded at a nozzle of the 3D printer is suspended in the air, and is cooled and solidified during the suspending process, thereby achieving the printing of the cantilever structure without support; and
when printing of the cantilever structure is completed, enabling the upper-layer magnetism creation platform to stop working, and enabling the lower-layer magnetism creation platform to continue to work, to firmly magnetically attract the 3D printed product onto the prototyping platform.
